(19) United States
(12) Patent Application Publication
(10) Pub. No.: US 2026/0359459 A1
(43) Pub. Date: Nov. 12, 2026

(54) Context Aware Permission and Device Resource Management

(71) Applicant: Bank of America Corporation, Charlotte, NC (US)

(72) Inventors: Adam King, Fort Mill, SC (US); George Albero, Charlotte, NC (US); Naga Vamsi Krishna Akkapeddi, Charlotte, NC (US); David Jayaprakash John, Tamil Nadu (IN); Ramesh Bhavana, Frisco, TX (US)

(21) Appl. No.: 19/203,357

(22) Filed: May 9, 2025

(51) Int. Cl. G06F 21/60

(52) U.S. Cl. CPC G06F 21/604; G06F 2221/2141

(57) ABSTRACT

Arrangements for controlling permissions and device resources are provided. In some examples, a computing platform may receive a request to access a resource on a computing device. The platform may receive application data associated with the computing device, device operation data and/or general contextual data. A machine learning model may receive the application data, device operation data and general contextual data as inputs and may output a permission recommendation. If the permission recommendation meets permission criteria, the request to access the resource may be granted and an instruction causing modification of permissions may be transmitted to the computing device and executed. If the permission recommendation does not meet permission criteria, the request to access the resource may be denied. In some examples, the machine learning model may output one or more resource allocation recommendations, such as modifications to storage allocations, priority associated with an application, or the like.

### BACKGROUND

Aspects of the disclosure relate to electrical computers, systems, and devices for context aware permission and device resource management.

Computing devices often have a variety of applications executing thereon. These applications may require a wide range of permissions and storage allocations, often leading to privacy concerns, inefficient resource use, and reduced device performance. Conventional systems provide static permissions and storage limits that remain active even when the application is not in use or when the permissions and storage are not needed. This may result in security risks, battery drain and/or storage mismanagement. Accordingly, it would be advantageous to provide a context aware, dynamic system for providing or revoking permissions and dynamically allocating storage and other resources.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with controlling permissions and device resources.

In some examples, a computing platform having at least one processor and memory may receive a request to access a resource on a computing device. The computing platform may receive application data associated with the computing device (e.g., usage data, frequency data, type of application and the like), device operation data and/or general contextual data. A machine learning model may receive the application data, device operation data and general contextual data as inputs and may output, for instance, a permission recommendation. If the permission recommendation meets permission criteria, the request to access the resource may be granted and an instruction causing modification of permissions may be transmitted to the computing device and executed to modify the permissions. If the permission recommendation does not meet permission criteria, the request to access the resource may be denied and an instruction preventing modification of permissions may be generated and transmitted to the computing device for execution.

In some examples, the machine learning model may output one or more resource allocation recommendations. For instance, modifications to storage allocations, priority associated with an application, or the like may be output. The computing platform may generate instructions to modify the one or more resource allocations and the instructions may be transmitted to the computing device for execution, causing modification of the one or more resource allocations.

In some examples, the computing platform may receive additional data and may monitor a status of the resource, the application, or the like. Upon detecting a triggering event (e.g., the application is no longer in use) the computing platform may generate additional modification instructions to further modify permissions, resource allocations, or the like, associated with the application no longer in use. The instructions may be transmitted to the computing device and executed, causing further modification of the permissions and/or resource allocations.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for permission and device resource control in accordance with one or more aspects described herein;

FIGS. 2A-2D depict an illustrative event sequence for permission and device resource control in accordance with one or more aspects described herein;

FIG. 3 illustrates an illustrative method for permission and device resource control according to one or more aspects described herein; and

FIG. 4 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, computing devices often have a plurality of applications executing thereon. Those applications may require a wide variety of permission and storage allocations. Conventional arrangements provide static permissions and resource allocations that might lead to privacy risks, storage risks, battery drain, and the like. Alternatively, in some examples, applications that have not been used frequently or recently may be disabled or removed from the computing device, which may cause a user to have to download the application again prior to subsequent use. Accordingly, aspects described herein provide for real-time, dynamic adjustment of application and device permissions and resource allocation based on real-time application usage and contextual data.

For instance, a computing platform may receive a request to access a resource. The request may include information about the resource as well as additional data related to application usage on a device, device operation data, general contextual data, and the like. The data may be input to a machine learning model to output one or more recommendations. For instance, the machine learning model may output whether to grant or deny the request to access the resource. In some examples, the machine learning model may identify storage partitions to execute in order to improve functioning of an application on a device, may identify one or more priorities or other resource allocations to provide to the device or application. Accordingly, performance of the device and/or application may be improved or optimized based on the real-time analysis of the contextual data. This may result in improved battery life, improved launch speed, reduced buffering or other delays, and the like.

These and various other arrangements will be discussed more fully below.

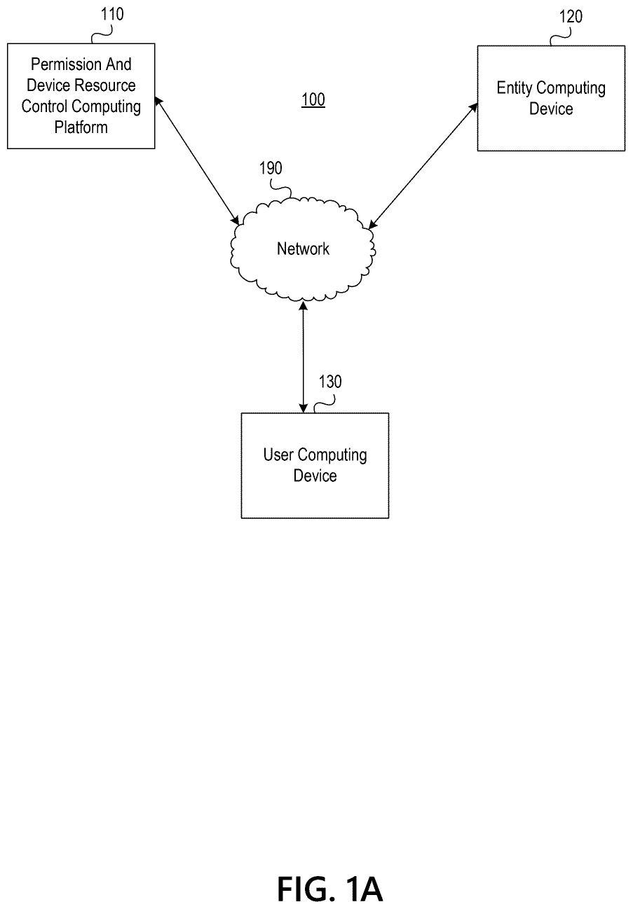

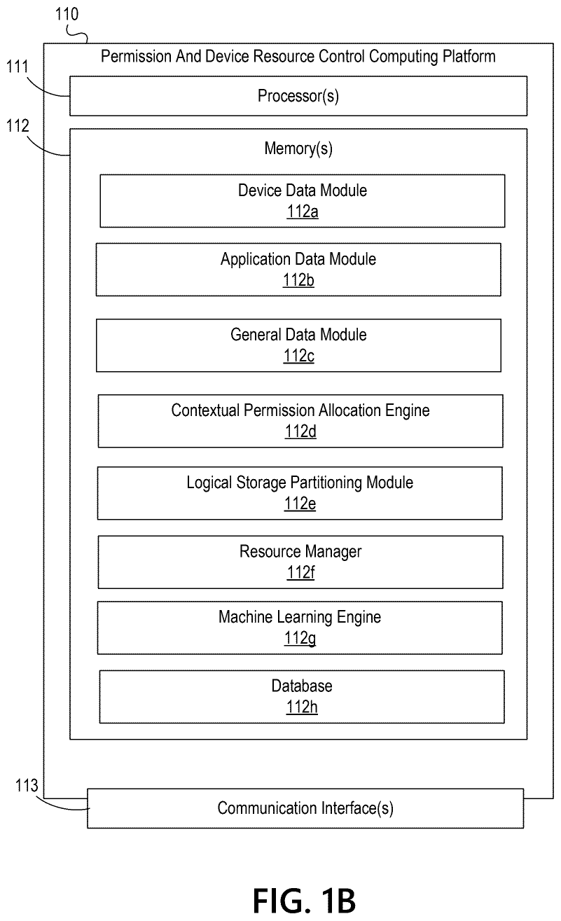

FIGS. 1A-1B depict an illustrative computing environment and devices for controlling permissions and device resources in accordance with one or more aspects described herein. Referring to FIG. 1A, computing environment 100 may include one or more computing devices and/or other computing systems. For example, computing environment 100 may include permission and device resource control computing platform 110, entity computing device 120 and user computing device 130.

Although one entity computing device 120 and one user computing device 130 are shown, any number of systems or devices may be used without departing from the invention.

Permission and device resource control computing platform 110 may be or include one or more computer components (e.g., servers, server blade, processor, memory, and the like) and may be configured to perform intelligent, dynamic, real-time evaluation of contextual data to provide device permissions and dynamic allocation of device or network resources based on contextual data, user specific data, device data, and the like. For instance, permission and device resource control computing platform 110 may receive a request (e.g., from an application) to access another application on the device, particular data on the device, a component or hardware of the device, and the like. Permission and device resource control computing platform 110 may receive contextual data including operational data of the computing device from which the request was received (e.g., central processing unit (CPU) usage, battery strength, and the like), network data such as available bandwidth, application usage (e.g., duration of usage, frequency of usage, and the like) for that particular computing device and/or user, and the like. In some examples, the contextual data may further include date, time of day, day of week, and the like, that may impact available resources, prioritization of resources, and the like.

In some examples, permission and device resource control computing platform 110 may input the received contextual data to a machine learning model. The machine learning model may be trained using historical data related to resource management, application usage, permissions and the like. The machine learning model may be executed to output predicted optimized permission and device resource controls. The output may be compared to one or more authorization criteria and, if the output meets the one or more criteria, the request may be permitted and one or more permissions may be modified on the computing device to enable access to the requested application, hardware, data, or the like. In addition, one or more resources associated with the computing device (e.g., CPU usage, bandwidth, memory or other data storage, and the like) may be modified to accommodate the request (e.g., based on real-time application usage and/or other data).

In some examples, permission and device resource control computing platform 110 may monitor usage of the device to determine when the application requesting access is no longer in use. Once a trigger is detected that the application requesting access is no longer in use, the granted permissions may be revoked and the application may be transitioned to a basic mode that limits the amount of resources designated to that application while maintaining the application as active in a background of the device (e.g., not removing the application or putting it into a sleep mode). The application may stay in basic mode until another request to access from the application is received and evaluated and/or until a triggering event is detected (e.g., a predetermined event, time or date to return the application to an active state from the basic mode).

Entity computing device 120 may be or include one or more computing devices or components (e.g., servers, desktop computers, laptop computers, tablets, mobile devices, smart devices, and the like) and may be configured to request access to an application, data, hardware, or the like, via the permission and device resource control computing platform 110. Entity computing device may be a device associated with an enterprise organization implementing the permission and device resource control computing platform 110 and may be used by one or more associates, agents, employees or the like of the enterprise organization.

User computing device 130 may be or include one or more computing devices or components (e.g., desktop computers, laptop computers, tablets, mobile devices, smart devices, and the like) and may be configured to request access to an application, data, hardware, or the like via the permission and device resource control computing platform 110. In some examples, user computing device 130 may be a personal device of a user, employee or agent of the enterprise organization for which the user has provided permission to the enterprise organization to optimize permission and resource management via the permission and device resource control computing platform 110.

As mentioned above, computing environment 100 also may include one or more networks, which may interconnect one or more of permission and device resource control computing platform 110, entity computing device 120, and/or user computing device 130. For example, computing environment 100 may include network 190. Network 190 may, in some examples, be a private network and include one or more sub-networks (e.g., Local Area Networks (LANs), Wide Area Networks (WANs), or the like). In some examples, network 190 may be a public network or may include a public network and private network in communication with each other. Network 190 may interconnect one or more computing devices associated with the organization and/or external to the organization. For example, permission and device resource control computing platform 110, entity computing device 120, and/or user computing device 130 may be connected via network 190.

Referring to FIG. 1B, permission and device resource control computing platform 110 may include one or more processors 111, memory 112, and communication interface 113. A data bus may interconnect processor(s) 111, memory 112, and communication interface 113. Communication interface 113 may be a network interface configured to support communication between permission and device resource control computing platform 110 and one or more networks (e.g., network 190, or the like). Memory 112 may include one or more program modules having instructions that when executed by processor(s) 111 cause permission and device resource control computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of permission and device resource control computing platform 110 and/or by different computing devices that may form and/or otherwise make up permission and device resource control computing platform 110.

For example, memory 112 may have, store and/or include device data module 112a. Device data module 112a may store instructions and/or data that may cause or enable the permission and device resource control computing platform 110 to receive data related to one or more particular devices, including, for instance, a device from which a request to access an application is received. The device data may include a type of device, operational parameters of the device, operating system of the device, and the like.

Permission and device resource control computing platform 110 may further have, store and/or include application data module 112b. Application data module 112b may store instructions and/or data that may cause or enable the permission and device resource control computing platform 110 to receive data related to one or more applications executing on the one or more devices. For instance, applications executing in a foreground, background, and the like, of the device may be received. Further, data such as frequency of use, duration of use, timing of use (e.g., time of day, day of week, day of month, or the like) may be received for the one or more applications.

Permission and device resource control computing platform 110 may further have, store and/or include general data module 112c. General data module 112c may store instructions and/or data that may cause or enable the permission and device resource control computing platform 110 to receive publicly available data related to general context, such as location, day of week, time of day, date, or the like.

Permission and device resource control computing platform 110 may further have, store and/or include contextual permission allocation engine 112d. Contextual permission allocation engine 112d may store instructions and/or data that may cause or enable the permission and device resource control computing platform 110 to use context aware application programming interface integration and real-time permission management frameworks to monitor inter-application communication and system events and automatically grant, revoke, and/or restrict permissions (e.g., for an application, system or the like) based on application context and activity. For instance, contextual permission allocation engine 112d may monitor application activity and system events and may modify permissions based on the monitored activity and/or other user or device data. In some examples, a request to access a feature, device or the like, may be granted or revoked based on the monitored activity. For instance, an application may request access to a microphone of a device. The contextual permission allocation engine 112d may analyze the request and provide permission when the application is active (e.g., based on monitored application activity) and may revoke the permission when the application is no longer active. Various other examples of granting and revoking permissions may be performed without departing from the invention.

Permission and device resource control computing platform 110 may further have, store and/or include logical storage partitioning module 112e. Logical storage partitioning module 112e may store instructions and/or data that may cause or enable the permission and device resource control computing platform 110 to use one or more device storage partitioning frameworks to dynamically segment application storage into, for example, a continuous gradient of logical partitions based on application state, usage frequency, activity levels, and the like. In some examples, logical storage partitioning module 112e may dynamically adjust storage along a spectrum between minimal (e.g., basic mode) and maximum (e.g., active in foreground) allocation, depending on real-time application requirements. For example, a streaming application executing on a computing device may receive incremental storage expansion during playback based on buffer needs and system load. The computing device may then gradually scale down the storage associated with the streaming application when it becomes idle, rather than shifting from sleep mode to fully active mode.

Permission and device resource control computing platform 110 may further have, store and/or include resource manager 112f. Resource manager 112f may store instructions and/or data that may cause or enable the permission and device resource control computing platform 110 to use one or more artificial intelligence/machine learning (AI/ML)-driven resource optimization models to analyze historical application usage and temporal patterns and system resource consumption and allocate resources contextually based on predicted usage. For instance, applications that are used during off hours, such as at night while a user is sleeping (e.g., a fitness tracker or other sleep monitoring application) may be granted higher priority during night time hours, while productivity applications (e.g., a work email application) may be prioritized during business hours. In some examples, the analysis may be performed by user such that a prediction may be unique to that particular user's habits and patterns of usage. Accordingly, a user that works off hours (e.g., noon to 8:00 p.m.) may have work email applications prioritized during that time period based on the analysis of the user's historical application usage and other patterns.

Permission and device resource control computing platform 110 may further have, store and/or include machine learning engine 112g. Machine learning engine 112g may store instructions and/or data that may cause or enable the permission and device resource control computing platform 110 to train, execute, update and/or validate one or more machine learning or artificial intelligence models. For instance, machine learning engine 112g may be trained using historical data related to device performance, application usage, application frequency, permissions or access, and the like in order to generate one or more resource allocations, storage partitions, and/or permissions recommendations or decisions. For instance, one or more stored correlations may be identified from the historical data based on relationships between device performance, application usage, contextual data, storage or resource allocation, and the like. Machine learning engine 112g may then receive subsequent data (e.g., device data, application usage data, general contextual data, and the like) as inputs and may output one or more recommendations or instructions for permissions, storage partitions, resource allocations, and the like.

Permission and device resource control computing platform 110 may further have, store and/or include database 112h. Database 112h may store data related to historical device data, application data, current application or device data, contextual data, and/or any other data to perform the functions of the permission and device resource control computing platform 110.

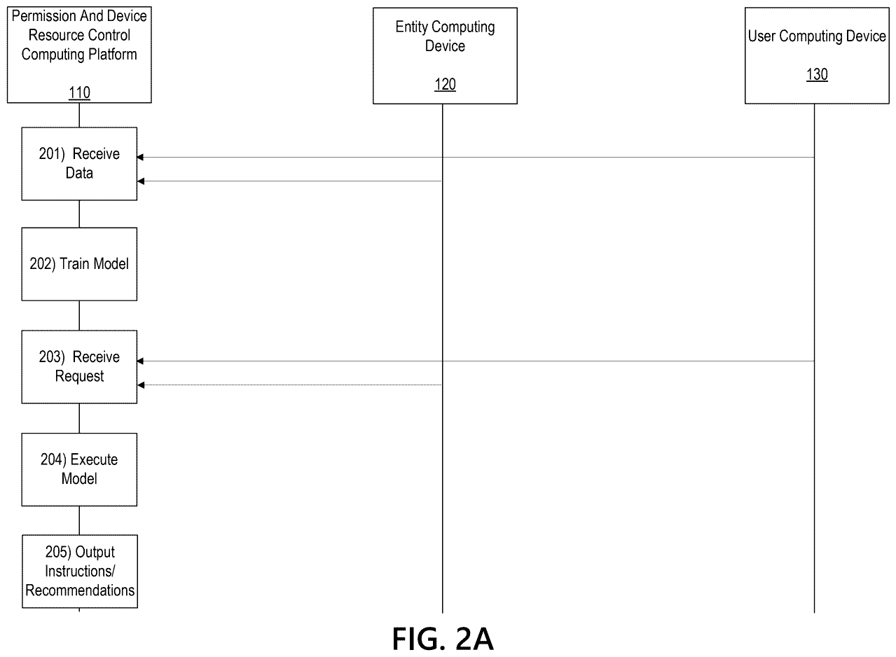

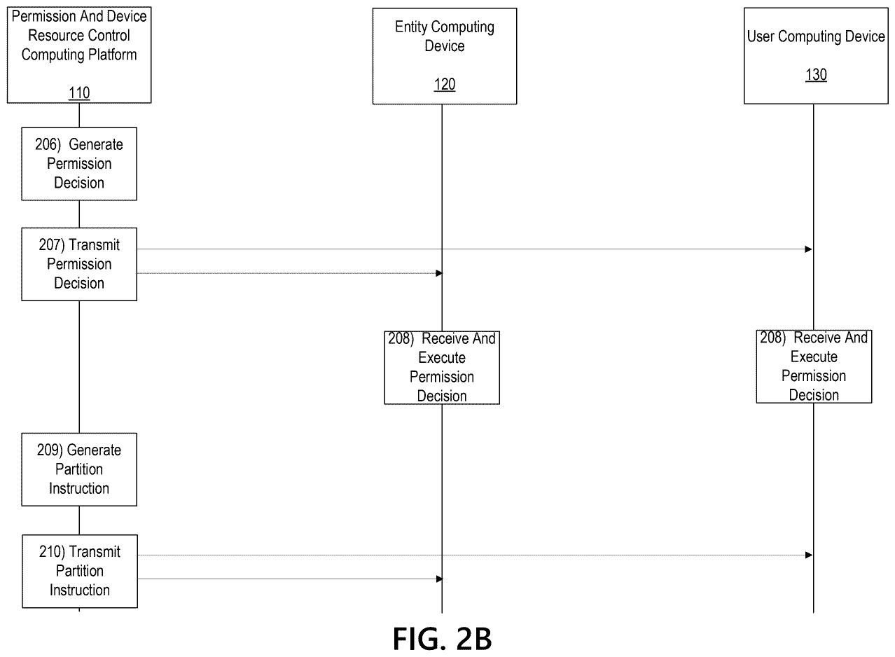

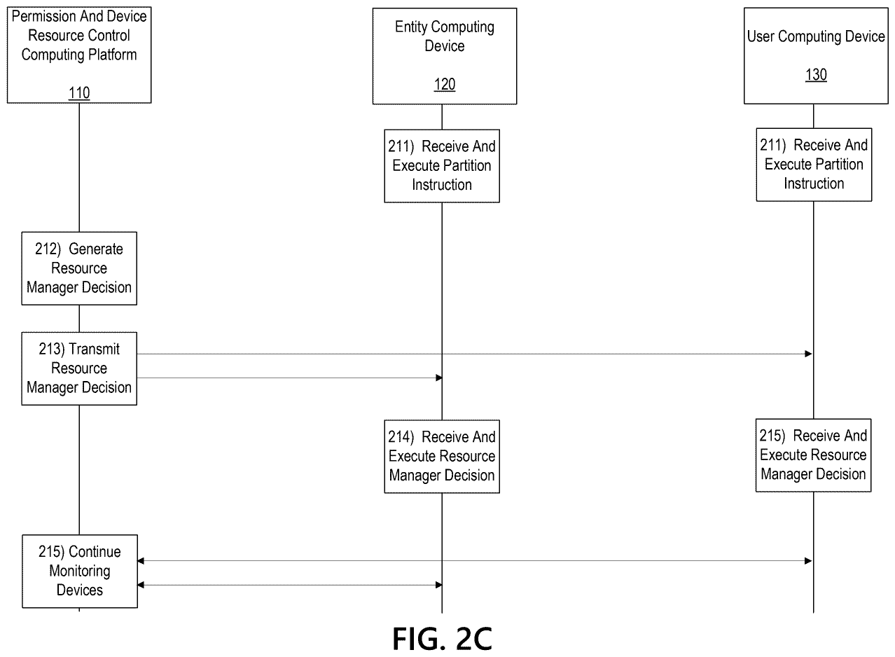

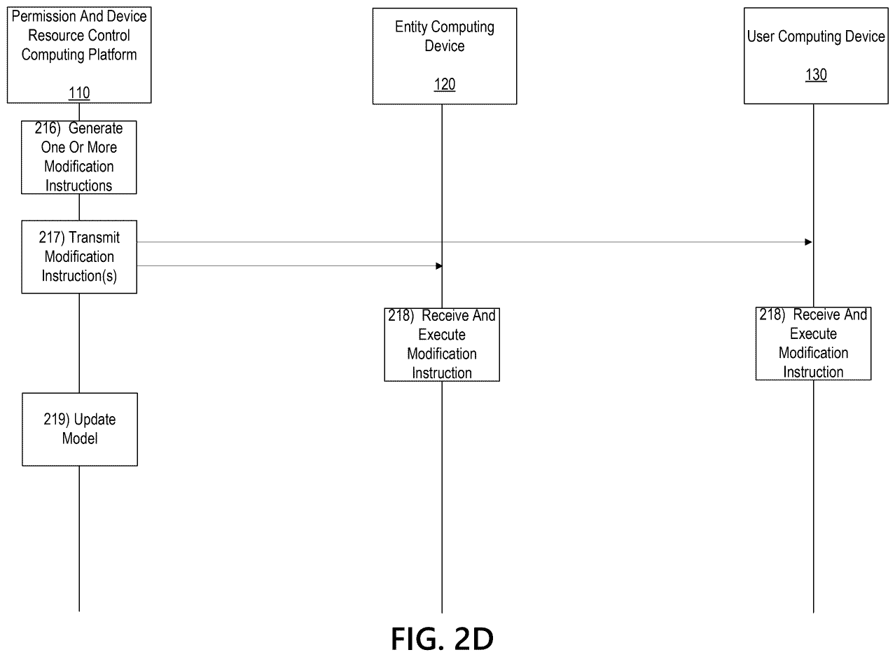

FIGS. 2A-2D depict one example illustrative event sequence for permission and device resource control in accordance with one or more aspects described herein. The events shown in the illustrative event sequence are merely one example sequence and additional events may be added, or events may be omitted, without departing from the invention. Further, one or more processes discussed with respect to FIGS. 2A-2D may be performed in real-time or near real-time.

With reference to FIG. 2A, at step 201, permission and device resource control computing platform 110 may receive data. For instance, permission and device resource control computing platform 110 may receive historical or other data from one or more computing devices, such as entity computing device 120, user computing device 130, or the like. The data may include device data (e.g., type of device, operating system, battery life, and the like), application and usage data (e.g., frequency of access, duration of access, type of application, or the like), as well as other general contextual data (e.g., time of day, day or week, and the like). Various other data may be received from additional devices, or the devices shown, without departing from the invention.

At step 202, permission and device resource control computing platform 110 may train a machine learning model. For instance, the data received at step 201 may be used to train the machine learning model to identify correlations, patterns or sequences in data in order to output instructions, recommendations, or the like, related to storage partitioning, resource management, permissions, and the like. For instance, the historical data may be sued to train the model to identify correlations between contextual and/or other data (e.g., application usage data, and the like) and one or more permissions, between application usage and available or assigned storage, and the like. Various other correlations may be identified and stored by the machine learning model without departing from the invention.

In some examples, training the machine learning model may include using one or more supervised learning techniques (e.g., decision trees, bagging, boosting, random forest, k-NN, linear regression, artificial neural networks, support vector machines, and/or other supervised learning techniques), self-supervised learning techniques (e.g., autoassociative self-supervised learning, contrastive self-supervised learning, non-contrastive self-supervised learning, or the like), unsupervised learning techniques (e.g., classification, regression, clustering, anomaly detection, artificial neutral networks, and/or other unsupervised models/techniques), and/or other techniques.

At step 203, permission and device resource control computing platform 110 may receive a request for access to a resource. For instance, permission and device resource control computing platform 110 may receive, from one or more computing devices, such as entity computing device 120, user computing device 130, or the like, a request from the device (e.g., an application executing on the device) to access a resource, such as an application, data, hardware on the device (e.g., microphone, speaker, or the like), and the like. While the arrangements shown and described include requests being received from entity computing device 120 and user computing device 130, a request may be received from a single device without departing from the invention. Further, when requests are received from multiple devices, they may be processed in parallel to ensure real-time dynamic processing of the requests. Accordingly, for the sake of example, the arrangements described will be described in the context of requests received from each of the devices.

At step 204, permission and device resource control computing platform 110 may execute the machine learning model. For instance, data received with the request for access (e.g., current application data (e.g., frequency of use, type of application, duration of use, and the like), current device data (e.g., battery life, and the like), current network conditions, general contextual data (e.g., time of day, day or week, and the like), and the like, may be input to the machine learning model and the model may be executed to output one or more instructions, recommendations, or the like, related to permissions or access, resource management, and/or storage partitioning at step 205. The real-time device data may be used to generate recommendations to dynamically modify operational parameters of the respective device, application, or the like, in order to optimize performance of the device.

Permission and device resource control computing platform 110 may analyze the outputs from the machine learning model to generate one or more executable instructions or commands for transmission to the requesting device(s), e.g., entity computing device 120, user computing device 130, or the like. Accordingly, with reference to FIG. 2B, at step 206, permission and device resource control computing platform 110 may generate a permission decision instruction. For instance, based on the output of the machine learning model, a permission decision associated with the requesting application may be generated. The permission decision may grant or deny permission to the requesting application to access the data, system, hardware or the like. In some examples, the permission decision may be based on general contextual data, such as a time of day, day or week, or the like. For instance, the machine learning model may evaluate the request based on current application usage data, application pattern data for that device or user, as well as general contextual data (e.g., is this an expected request or expected time for this application to be accessing the resource). Based on the output, the permission and device resource control computing platform 110 may evaluate the output to determine if criteria are met to permit access. If so, the permission may be granted and if not, the permission may be denied. The generated instruction may then reflect the determination of whether the output of the machine learning model meets the criteria to permit access.

At steep 207, permission and device resource control computing platform 110 may transmit or send the generated permission decision instruction to the entity computing device 120 and user computing device 130. In some examples, the decision for each device may be different (e.g., permission may be granted for one device and denied for another based on parallel processing of the requests received from each respective device). In some examples, sending the permission decision instruction to the entity computing device 120 and user computing device 130 may cause the respective device to execute the instruction.

For instance, at step 208, each of entity computing device 120 and user computing device 130 may receive and execute the permission decision instruction. Accordingly, based on the instruction, the respective computing device may modify access rights to allow permission to the requested resource (if permission decision indicates to grant permission) or may deny the request to access the resource

At step 209, permission and device resource control computing platform 110 may generate, based on the output of the machine learning model, a partition instruction. For instance, based on the analysis of the current device data, application usage data, and the like, the machine learning model may output one or more recommendations for storage partitioning to, for instance, optimize performance of the requesting device or application requesting access. The machine learning model may output a particular segmentation of storage based on, for instance, application usage, or may recommend a gradual increase or a schedule or gradient of increases in order to optimize the applications executing on the device. Based on the recommended partition, permission and device resource control computing platform 110 may generate an instruction or command for transmission to the respective device(s) (e.g., entity computing device 120, user computing device 130, or the like).

At step 210, permission and device resource control computing platform 110 may transmit or send the generated partition instruction to the entity computing device 120 and user computing device 130. The partition for each device may be the same or different based on current application usage, usage patterns, and the like, for the respective device. Transmitting the instruction may cause the respective computing device to execute the instruction, thereby modifying allocated storage based on the instruction.

With reference to FIG. 2C, at step 211, entity computing device 120 and/or user computing device 130 may receive and execute the partitioning instruction. For instance, each of entity computing device 120 and/or user computing device 130 may modify storage allocated to one or more applications based on the partitioning instruction. Accordingly, in use applications that may require additional storage to improve or optimize performance, may receive an increase (e.g., one time or gradual increase) in allocated storage to improve performance.

At step 212, based on the machine learning analysis of the current data, permission and device resource control computing platform 110 may generate a resource manager decision. The resource manager decision may identify priorities for one or more applications executing on a device (e.g., entity computing device 120, user computing device 130, or the like) based on current application usage, general contextual data (e.g., time of day, day of week, or the like) and may allocate resources to applications that are historically (e.g., based on usage patterns) used at that time, on that particular day of the week, or the like. Further, resources may be removed from other applications that are not expected to be in heavy use at that particular time, or in that particular context. Accordingly, the resource manager decision may allocate and remove resources from various applications, or the like, dynamically, in order to continuously optimize device performance, application performance, and the like. For instance, predictive scaling for CPU may be performed for applications increasing or decreasing in usage based on time of day, known patterns, or the like.

At step 213, permission and device resource control computing platform 110 may transmit or send the generated resource manager decision to the entity computing device 120 and user computing device 130. The resource manager decision for each device may be the same or different based on current application usage, usage patterns, and the like, for the respective device. Transmitting the instruction may cause the respective computing device to execute the instruction, thereby modifying allocated resources based on the instruction.

At step 214, entity computing device 120 and/or user computing device 130 may receive and execute the resource manager decision. For instance, each of entity computing device 120 and/or user computing device 130 may modify resources allocated to one or more applications based on the resource manager decision. Accordingly, in-use applications that may require additional resources to improve or optimize performance, may receive those resources, while other applications not currently in use or not expected to be in use may be transferred to a basic mode in which the application may remain functional on the device (e.g., it does not need to be downloaded again for subsequent use) but is allocated and using the fewest resources possible to maintain the application in a mode that might be considered one step above a “sleep mode.”

At step 215, permission and device resource control computing platform 110 may continue monitoring the devices (e.g., entity computing device 120, user computing device 130, and the like) to detect changes in application usage, device usage, or the like. In some examples, subsequent device and/or application data may be received from the device(s) and input to the machine learning model. The machine learning model may be executed to output updated recommendations for permissions, resource management, storage allocation, and the like.

Additionally or alternatively, with reference to FIG. 2D, at step 216, upon detecting a triggering event (e.g., an application previously in use is no longer in use, an application that requested access to a resource is no longer active on the device, application not in use for a at least a threshold time period, or the like), permission and device resource control computing platform 110 may generate one or more modification instructions. For instance, modification instructions may include transferring or transitioning an application from an active mode to a basic mode, revoking permissions granted to an application or device to access a resource, further modifying resource allocations based on the triggering event or updated data, and the like.

At step 217, permission and device resource control computing platform 110 may transmit or send the generated modification instructions to one or more of entity computing device 120 and/or user computing device 130. Transmitting the instruction may cause the respective computing device to execute the instruction and further modify one or more operations, resource allocations, or the like.

At step 218, entity computing device 120 and/or user computing device 130 may receive and execute the modification instructions. Executing the modification instruction may cause the respective computing device to change resource allocations, permissions, or the like.

At step 219, permission and device resource control computing platform 110 may update and/or validate the machine learning model. For instance, based on one or more instructions or commands executed by the one or more devices, as well as monitoring data associated with the devices, the machine learning model may be updated and/or validated in order to continue to improve accuracy of outputs associated with the model.

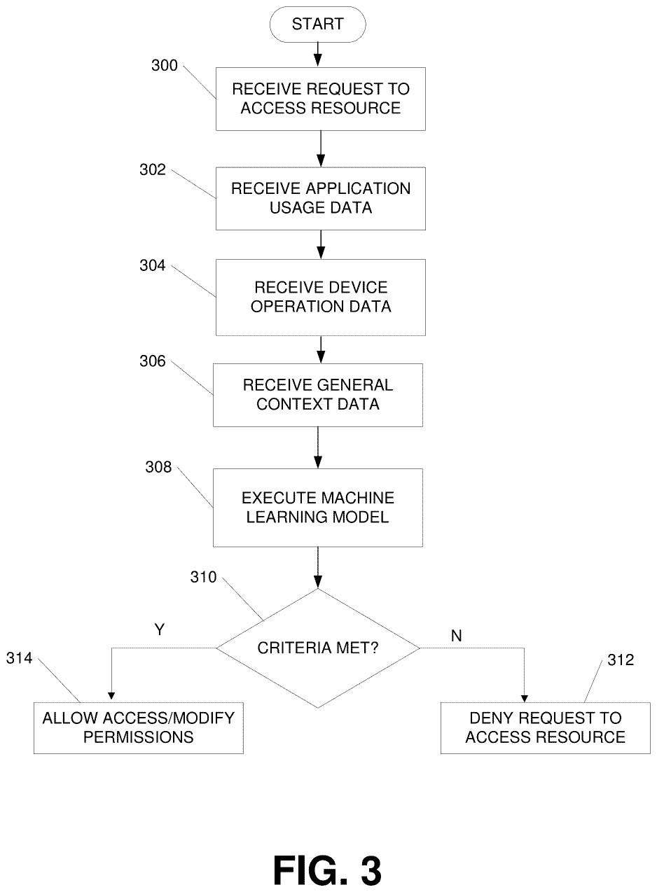

FIG. 3 is a flow chart illustrating one example method of controlling device permissions and resources in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, permission and device resource control computing platform 110 may receive a request to a resource. For instance, permission and device resource control computing platform may receive a request to access a resource via a user computing device 130 and/or an entity computing device 120. In some examples, the resource may be received from an application executing on the computing device and may include hardware of the device (e.g., microphone or the like), data, another application, or the like.

At step 302, permission and device resource control computing platform 110 may receive application usage data from the computing device (e.g., entity computing device 120 and/or user computing device 130) requesting to access the resource. For instance, a frequency of usage of the application, a type of application, a duration of usage, and the like, for one or more applications on the respective computing device may be received.

At step 304, permission and device resource control computing platform 110 may receive device operation data from the computing device (e.g., entity computing device 120, user computing device 130, or the like). The device operation data may include current CPU usage, current connections, network bandwidth, memory or data storage availability and/or allocations, and the like.

At step 306, permission and device resource control computing platform 110 may receive general context data. The general context data may include time of day, day of week, date, and the like. In some examples, the general context data may be received from one or more of entity computing device 120, user computing device 130, and/or other devices.

At step 308, permission and device resource control computing platform 110 may execute a machine learning model. In some examples, executing the machine learning model may include inputting, to the model, the application usage data, device operation data and the general context data to output permission recommendations. For instance, the machine learning model may output a recommendation or instruction to provide, revoke, or the like, permission to access the resource on the computing device.

In some examples, executing the machine learning model may further including outputting, based on the inputs described above, one or more resource allocation recommendations, such as storage partitioning recommendations, application priority recommendations, or the like.

At step 310, permission and device resource control computing platform 110 may determine whether the permission recommendations meet permission criteria. For instance, permission and device resource control computing platform 110 may determine whether the permission recommendations are within expected patterns for that application and that particular user or computing device for that particular context. In some arrangements, determining whether the permission criteria are met may include analyzing the permission recommendations to determine whether they include a recommendation to provide access to the resource, or whether they include a recommendation to deny access. In some examples, the machine learning model may output a score associated with the permission recommendation and the score may be compared to a threshold (e.g., permission criteria) to determine whether the permission should be granted.

In some examples, determining whether the recommendation meets permission criteria may include evaluating the permission recommendation and the one or more resource allocation recommendations to determine whether, together, the context is appropriate to grant the requested permissions.

If, at step 310, the permission criteria are not met, at step 312, permission and device resource control computing platform 110 may generate an instruction preventing modification of permissions associated with the requested resource. The instruction may be transmitted to the computing device and executed, which may cause the computing device to prevent modification of the permissions allowing access to the resource (e.g., deny the request). In some examples, the instruction may further include an instruction causing the requesting application to be transitioned to a basic mode in which minimal resources are allocated to that application. The application might not be taken offline but may be provided limited resources to maintain the application on the computing device. The application may remain in this basic mode until another request for access is received.

If, at step 310, the permission criteria are met, at step 314, the requested access to the application may be provided and the permission and device resource control computing platform 110 may generate an instruction to modify permissions associated with the resource. The permission and device resource control computing platform 110 may transmit or send the instruction to the computing device which may cause the computing device to execute the instruction and modify the permissions, thereby granting access to the resource.

In examples in which one or more resource allocation recommendations are output by the machine learning model, permission and device resource control computing platform 110 may generate further instructions to modify the one or more resource allocations. The instruction to modify the one or more resource allocations may be transmitted to the computing device and executed, causing the computing device to modify the one or more resource allocations.

In some examples, permission and device resource control computing platform 110 may receive additional application usage device, device operational data, and the like, and may monitor the additional data for one or more triggering events (e.g., an application no longer in use). Upon detection of a triggering event, permission and device resource control computing platform 110 may generate one or more instructions causing further modification of permissions, resource allocations, or the like. The instruction may be transmitted to the computing device and executed, causing the modification to occur.

As discussed herein, the arrangements described provide for dynamic, real-time, modification or adjustment of permissions, resource allocations, and the like, at a computing device, to optimize device and/or application performance. For instance, based on real-time data analyzed using machine learning, permissions, storage, system resources, and the like, can be adjusted in real-time. Factors such as application usage, user behaviors and device operation context can be used to provide real-time adjustment of permissions, storage allocation, application priority, and the like.

As discussed herein, a contextual permission allocation engine within the computing platform may grant or revoke permissions based on live or real-time (or near real-time) application data and activity, inter-application or system events, and the like. In addition, an AI/ML powered resource manager of the computing platform can optimize performance for privacy and efficiency across all usage conditions. Further, a logical storage partitioning system of the computing platform may advance the arrangements described herein beyond static storage modes and may dynamically adjust storage allocation along a continuous gradient based on application usage, usage frequency, overall system state, and the like.

While aspects discussed herein are directed to initiation of the process based on a request to access a resource, in some examples, the process may be executed on a continuous or near continuous basis in order to generate recommendations, predictions, execute modifications, and the like, on an ongoing basis. Additionally or alternatively, data may be received and analyzed on a periodic or aperiodic basis to identify and execute dynamic adjustments.

Further, while examples described herein generally include requests received from the physical world, in some examples, virtual requests may be received and processed in a similar manner. Accordingly, the arrangements described may provide an omni-channel experience where a user can perform a transaction in one location or from one device and may continue the transaction via other devices or locations. The contextual data may be used to build the transaction, identify where it is being initiated, provide authentication, and the like. The arrangements described may then be used to evaluate the transaction for potential unauthorized activity by analyzing contextual data as compared to expected behaviors of the user or patterns associated with the device. A protocol in use may also be evaluated to determine whether potential unauthorized activity exists in the transaction.

As discussed herein, various inputs may be analyzed to determine whether to grant/revoke permissions, modify resource allocations, an the like. In some examples, the decision layer may include inputs from various usage monitors (e.g., computing device usage monitors), resource predictors, context analyzers, and the like, in order to determine whether to grant or revoke permissions, whether to modify resource allocations, and the like.

In some examples, in which an application is returned to a basic mode in which minimal resources are allocated to the application, the application may remain in that state until another request for access is received. Additionally or alternatively, if pattern data indicates that the application is generally used on particular days of the month (e.g., a 1^{st} and 15^{th}, for example), the application may be automatically transitioned from basic mode to the fully active mode on or in advance of those dates to enable full access to the user based on the anticipated request to access the application. Accordingly, in some examples, an application may reactivate based on a predetermined schedule or on an expected date.

Further, the arrangements described may provide intelligent storage allocation in anticipation of increased activity. For instance, if high volume of transactions or other operations are performed at an end of the month, end of the quarter, or the like, in anticipation of the increase, storage and other resources may be allocated to the application executing the transactions or operations in advance of the increase, to enable a smooth transition to the increased processing needed to accommodate the increased volume.

While some example use cases are provided herein, some addition examples are provided below. The following examples are merely some examples and do not limit the invention. Various other examples may be used without departing from the invention.

In some examples, a user may activate a music application at night to provide white noise when sleeping and fitness tracker application may be used at night to monitor sleep patterns. Based on music application and fitness tracker application usage patterns, the arrangements described herein may determine that, based on a current time of day, the music application and fitness tracker application should be prioritized and have additional resources (e.g., CPU, storage, or the like) allocated to them, while reducing resources associated with productivity applications (e.g., a work email application).

In another example, the arrangements described herein may be used to pre-load an application to enable a user to pick up where the user left off at a last interaction with the application. The application may be transitioned to a basic mode upon detecting the application is no longer in active use and, when reactivated, may resume at a point at which the user last used the application.

The arrangements described herein may be integrated at the operating system level and/or may be part of a managed enterprise environment that can supplement power and permission controls, or the like. The arrangements described may be used with various different operating systems and different types of devices. In some examples, the arrangements described may override default arrangements of an operating system (e.g., that may transition an application to sleep mode or may disable the application for lack of use). Alternatively, the arrangements may provide a layer between applications remaining active and the default action for any particular operating system for applications not used frequently. For instance, the arrangements described herein may be a first step to reduce resources associated with an application prior to the application being transitioned to a sleep mode or disabled by the operating system.

Further, the arrangements described herein may be used to ensure expected users of an application are taking particular actions. For instance, one or more applications may be actively used by employees of an enterprise organization. However, in some examples, only an owner or person in authority can provide specific requested data (e.g., based on regulatory requirements). The arrangements described may be used to ensure that the requested data is being received from the required user and, if pattern behavior suggests it is not the required user, a notification may be transmitted (e.g., to a pre-stored email address, phone number, or the like) of the required user requesting confirmation. This can ensure that data is accurate and received seamlessly based on the contextual data.

Further, the arrangements described herein enable fine tuning pf privacy profiles based on permission grant or revocation. The privacy profiles may be further modified based on preference of the enterprise organization, risk posture, and the like.

In addition, the arrangements described may further resolve conflicts between applications. By evaluating, in real-time, application usage, user patterns, and the like, as well as historical data, the system may identify how critical an application is and identify an appropriate priority to each of the conflict applications to resolve the conflict.

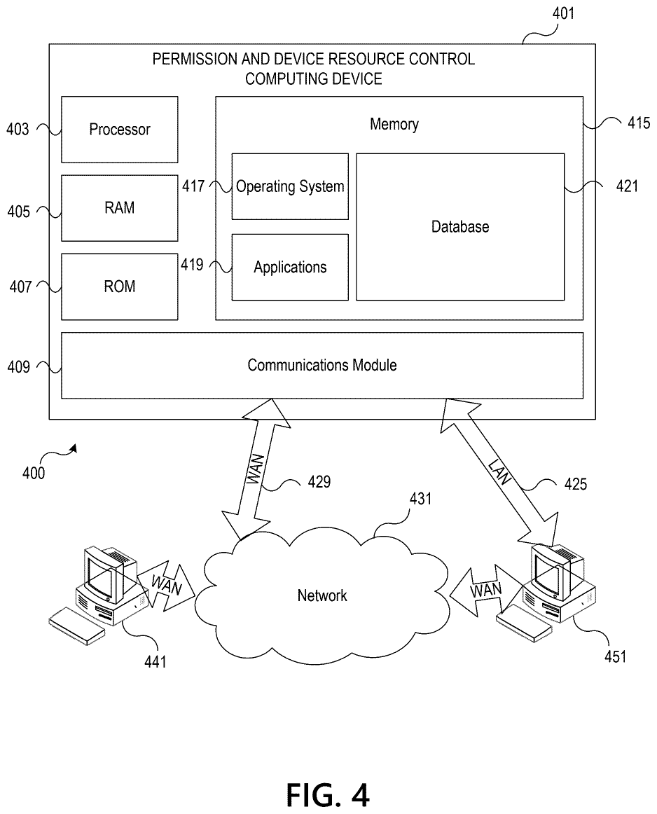

FIG. 4 depicts an illustrative operating environment in which various aspects of the present disclosure may be implemented in accordance with one or more example embodiments. Referring to FIG. 4, computing system environment 400 may be used according to one or more illustrative embodiments. Computing system environment 400 is only one example of a suitable computing environment and is not intended to suggest any limitation as to the scope of use or functionality contained in the disclosure. Computing system environment 400 should not be interpreted as having any dependency or requirement relating to any one or combination of components shown in illustrative computing system environment 400.

Computing system environment 400 may include permission and device resource control computing device 401 having processor 403 for controlling overall operation of permission and device resource control computing device 401 and its associated components, including Random Access Memory (RAM) 405, Read-Only Memory (ROM) 407, communications module 409, and memory 415. Permission and device resource control computing device 401 may include a variety of computer readable media. Computer readable media may be any available media that may be accessed by permission and device resource control computing device 401, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by permission and device resource control computing device 401.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on permission and device resource control computing device 401. Such a processor may execute computer-executable instructions stored on a computer-readable medium.

Software may be stored within memory 415 and/or storage to provide instructions to processor 403 for enabling permission and device resource control computing device 401 to perform various functions as discussed herein. For example, memory 415 may store software used by permission and device resource control computing device 401, such as operating system 417, application programs 419, and associated database 421. Also, some or all of the computer executable instructions for permission and device resource control computing device 401 may be embodied in hardware or firmware. Although not shown, RAM 405 may include one or more applications representing the application data stored in RAM 405 while permission and device resource control computing device 401 is on and corresponding software applications (e.g., software tasks) are running on permission and device resource control computing device 401.

Communications module 409 may include a microphone, keypad, touch screen, and/or stylus through which a user of permission and device resource control computing device 401 may provide input, and may also include one or more of a speaker for providing audio output and a video display device for providing textual, audiovisual and/or graphical output. Computing system environment 400 may also include optical scanners (not shown).

Permission and device resource control computing device 401 may operate in a networked environment supporting connections to one or more remote computing devices, such as computing devices 441 and 451. Computing devices 441 and 451 may be personal computing devices or servers that include any or all of the elements described above relative to permission and device resource control computing device 401.

The network connections depicted in FIG. 4 may include Local Area Network (LAN) 425 and Wide Area Network (WAN) 429, as well as other networks. When used in a LAN networking environment, permission and device resource control computing device 401 may be connected to LAN 425 through a network interface or adapter in communications module 409. When used in a WAN networking environment, permission and device resource control computing device 401 may include a modem in communications module 409 or other means for establishing communications over WAN 429, such as network 431 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive a request to access a resource via a computing device;
receive, from one or more applications executing on the computing device, application usage data;
receive, from the computing device, device operation data;
receive general context data;
execute a machine learning model, wherein executing the machine learning model includes inputting the application usage data, device operation data and general context data to the machine learning model to output permission recommendations;
determine whether the permission recommendations meet permission criteria;
responsive to determining that the permission recommendations do not meet permission criteria, deny the request to access the resource, wherein denying the request to access the resource includes:
generating an instruction preventing modification of permissions associated with the resource; and
transmitting the instruction preventing modification of permissions to the computing device, wherein transmitting the instruction to the computing device causes the computing device to execute the instruction and prevent modification of the permissions associated with the resource;
responsive to determining that the permission recommendations meet the permission criteria, granting the request to access the resource, wherein granting the request to access the resource includes:
generating an instruction modifying permissions associated with the resource; and
transmitting the instruction modifying the permissions to the computing device, wherein transmitting the instruction modifying the permissions to the computing device causes the computing device to execute the instruction modifying the permissions and modify the permissions associated with the resource at the computing device.

2. The computing platform of claim 1, wherein executing the machine learning model further includes inputting the application usage data, device operation data and general context data to the machine learning model to output one or more resource allocation recommendations.

3. The computing platform of claim 2, wherein the one or more resource allocation recommendations include a recommendation to partition storage associated with an application executing on the computing device.

4. The computing platform of claim 2, wherein the one or more resource allocation recommendations include a recommendation to modify a priority of an application executing on the computing device.

5. The computing platform of claim 2, further including instructions that, when executed, cause the computing platform to:
generate an instruction to modify one or more resource allocations of the computing device; and
transmit, to the computing device, the instruction to modify the one or more resource allocations of the computing device, wherein transmitting the instruction to modify the one or more resource allocations of the computing device causes the computing device to execute the instruction to modify the one or more resource allocations and modify the one or more resource allocations.

6. The computing platform of claim 5, further including instructions that, when executed, cause the computing platform to:
receive additional application usage data and device operation data from the computing device;
monitor the received additional application usage data and device operation data from the computing device to detect a triggering event;
responsive to detecting the triggering event, generate an instruction to further modify at least one of: the permissions associated with the resource or the modified one or more resource allocations; and
transmit, to the computing device, the generated instruction to further modify the at least one of: the permissions associated with the resource or the modified one or more resource allocations, wherein transmitting the generated instruction to further modify the at least one of: the permissions associated with the resource or the modified one or more resource allocations causes the computing device to execute the generated instruction to further modify the at least one of: the permissions associated with the resource or the modified one or more resource allocations and further modify the at least one of: the permissions associated with the resource or the modified one or more resource allocations.

7. The computing platform of claim 6, wherein the triggering event includes detecting an indication that an application executing on the computing device is no longer in use.

8. The computing platform of claim 1, wherein the application usage data includes at least one of: type of application, frequency of use of application, or duration of use of application.

9. A method, comprising:
receiving, by a computing platform, the computing platform having at least one processor, and memory, a request to access a resource via a computing device;
receiving, by the at least one processor and from one or more applications executing on the computing device, application usage data;
receiving, by the at least one processor and from the computing device, device operation data;
receiving, by the at least one processor, general context data;
executing, by the at least one processor, a machine learning model, wherein executing the machine learning model includes inputting the application usage data, device operation data and general context data to the machine learning model to output permission recommendations;
determining, by the at least one processor, whether the permission recommendations meet permission criteria;
responsive to determining that the permission recommendations do not meet permission criteria, denying, by the at least one processor, the request to access the resource, wherein denying the request to access the resource includes:
generating an instruction preventing modification of permissions associated with the resource; and
transmitting the instruction preventing modification of permissions to the computing device, wherein transmitting the instruction to the computing device causes the computing device to execute the instruction and prevent modification of the permissions associated with the resource;
responsive to determining that the permission recommendations meet the permission criteria, granting, by the at least one processor, the request to access the resource, wherein granting the request to access the resource includes:
generating an instruction modifying permissions associated with the resource; and
transmitting the instruction modifying the permissions to the computing device, wherein transmitting the instruction modifying the permissions to the computing device causes the computing device to execute the instruction modifying the permissions and modify the permissions associated with the resource at the computing device.

10. The method of claim 9, wherein executing the machine learning model further includes inputting the application usage data, device operation data and general context data to the machine learning model to output one or more resource allocation recommendations.

11. The method of claim 10, wherein the one or more resource allocation recommendations include a recommendation to partition storage associated with an application executing on the computing device.

12. The method of claim 10, wherein the one or more resource allocation recommendations include a recommendation to modify a priority of an application executing on the computing device.

13. The method of claim 10, further including:
generating, by the at least one processor, an instruction to modify one or more resource allocations of the computing device; and
transmitting, by the at least one processor and to the computing device, the instruction to modify the one or more resource allocations of the computing device, wherein transmitting the instruction to modify the one or more resource allocations of the computing device causes the computing device to execute the instruction to modify the one or more resource allocations and modify the one or more resource allocations.

14. The method of claim 13, further including:
receiving, by the at least one processor, additional application usage data and device operation data from the computing device;
monitoring, by the at least one processor, the received additional application usage data and device operation data from the computing device to detect a triggering event;
responsive to detecting the triggering event, generating, by the at least one processor, an instruction to further modify at least one of: the permissions associated with the resource or the modified one or more resource allocations; and
transmitting, by the at least one processor and to the computing device, the generated instruction to further modify the at least one of: the permissions associated with the resource or the modified one or more resource allocations, wherein transmitting the generated instruction to further modify the at least one of: the permissions associated with the resource or the modified one or more resource allocations causes the computing device to execute the generated instruction to further modify the at least one of: the permissions associated with the resource or the modified one or more resource allocations and further modify the at least one of: the permissions associated with the resource or the modified one or more resource allocations.

15. The method of claim 14, wherein the triggering event includes detecting an indication that an application executing on the computing device is no longer in use.

16. The method of claim 9, wherein the application usage data includes at least one of: type of application, frequency of use of application, or duration of use of application.

17. One or more non-transitory computer-readable media storing instructions that, when executed by a computing platform comprising at least one processor, memory, and a communication interface, cause the computing platform to:
receive a request to access a resource via a computing device;
receive, from one or more applications executing on the computing device, application usage data;
receive, from the computing device, device operation data;
receive general context data;
execute a machine learning model, wherein executing the machine learning model includes inputting the application usage data, device operation data and general context data to the machine learning model to output permission recommendations;
determine whether the permission recommendations meet permission criteria;
responsive to determining that the permission recommendations do not meet permission criteria, deny the request to access the resource, wherein denying the request to access the resource includes:
generating an instruction preventing modification of permissions associated with the resource; and
transmitting the instruction preventing modification of permissions to the computing device, wherein transmitting the instruction to the computing device causes the computing device to execute the instruction and prevent modification of the permissions associated with the resource;
responsive to determining that the permission recommendations meet the permission criteria, granting the request to access the resource, wherein granting the request to access the resource includes:
generating an instruction modifying permissions associated with the resource; and
transmitting the instruction modifying the permissions to the computing device, wherein transmitting the instruction modifying the permissions to the computing device causes the computing device to execute the instruction modifying the permissions and modify the permissions associated with the resource at the computing device.

18. The one or more non-transitory computer-readable media of claim 17, wherein executing the machine learning model further includes inputting the application usage data, device operation data and general context data to the machine learning model to output one or more resource allocation recommendations.

19. The one or more non-transitory computer-readable media of claim 18, further including instructions that, when executed, cause the computing platform to:
generate an instruction to modify one or more resource allocations of the computing device; and
transmit, to the computing device, the instruction to modify the one or more resource allocations of the computing device, wherein transmitting the instruction to modify the one or more resource allocations of the computing device causes the computing device to execute the instruction to modify the one or more resource allocations and modify the one or more resource allocations.

20. The one or more non-transitory computer-readable media of claim 19, further including instructions that, when executed, cause the computing platform to:
receive additional application usage data and device operation data from the computing device;
monitor the received additional application usage data and device operation data from the computing device to detect a triggering event;
responsive to detecting the triggering event, generate an instruction to further modify at least one of: the permissions associated with the resource or the modified one or more resource allocations; and
transmit, to the computing device, the generated instruction to further modify the at least one of: the permissions associated with the resource or the modified one or more resource allocations, wherein transmitting the generated instruction to further modify the at least one of: the permissions associated with the resource or the modified one or more resource allocations causes the computing device to execute the generated instruction to further modify the at least one of: the permissions associated with the resource or the modified one or more resource allocations and further modify the at least one of: the permissions associated with the resource or the modified one or more resource allocat
